(19) United States
(12) Patent Application Publication
(10) Pub. No.: US 2026/0046781 A1
(43) Pub. Date: Feb. 12, 2026

(54) Dynamic Transmission Power Indication for TxRU Adaptation

(71) Applicant: Apple Inc., Cupertino, CA (US)

(72) Inventors: Hong HE, San Jose, CA (US); Dawei ZHANG, Saratoga, CA (US); Wei ZENG, Saratoga, CA (US); Haitong SUN, Saratoga, CA (US); Sigen YE, San Diego, CA (US); Jie CUI, San Jose, CA (US)

(21) Appl. No.: 19/102,951

(22) PCT Filed: Aug. 10, 2023
(86) PCT No.: PCT/US2023/029969

§ 371 Date: Feb. 11, 2025

Related U.S. Application Data
(60) Provisional application No. 63/371,101, filed on Aug. 11, 2022.

(51) Int. Cl. H04W 52/14; H04W 52/16; H04W 52/32

(52) U.S. Cl. CPC H04W 52/143; H04W 52/16; H04W 52/325

(57) ABSTRACT

A user equipment (UE) configured to decode, based on signals received from a base station, a set of power offset values, decode, based on signals received from the base station, a downlink control information (DCI), the DCI indicating a power offset value from the set of power offset values and determine a transmission power for a downlink signal to be transmitted by the base station based on at least the power offset value indicated by the DCI.

### PRIORITY/INCORPORATION BY REFERENCE

This application claims priority to U.S. Provisional Application Ser. No. 63/371,101 filed on Aug. 11, 2022, and entitled “Dynamic Transmission Power Indication for TxRU Adaptation,” the entirety of which is incorporated herein by reference.

### BACKGROUND

A user equipment (UE) may connect to a network via a base station. Typically, energy saving techniques that are implemented on the network side and/or the UE side are designed to conserve power at the UE. However, energy consumption is also a concern on the network side and techniques designed to mitigate network power consumption may also be utilized.

The network may utilize different types of power saving techniques that include dynamically switching on and off one or more network components. For example, the base station may be configured to perform transceiver unit (TxRU) adaptation. TxRU adaptation refers to a network power saving technique where the base station dynamically switches off and on transceiver chains depending on factors such as, but not limited to, traffic load and a number of connected devices. This type of network power saving technique may trigger a transmission power update for certain types of downlink signals and/or channels. Under conventional circumstances, to indicate the updated transmission power to the UE, the base station may transmit a transmission power indication for downlink signals via a system information block (SIB) or radio resource control (RRC) signaling. However, the conventional procedures are performed on a per-UE basis which may create a significant signaling overhead. In addition, the speed with which the conventional procedures may be performed are undesirable for the dynamic nature of TxRU adaptation. Accordingly, it has been identified that there is a need for techniques configured to enable the UE to determine when the transmission power for downlink signals has changed to support the implementation of this type of network power saving technique.

### SUMMARY

Some exemplary embodiments are related to an apparatus of a user equipment (UE), the apparatus having processing circuitry configured to decode, based on signals received from a base station, a set of power offset values, decode, based on signals received from the base station, a downlink control information (DCI), the DCI indicating a power offset value from the set of power offset values and determine a transmission power for a downlink signal to be transmitted by the base station based on at least the power offset value indicated by the DCI.

Other exemplary embodiments are related to a processor configured to decode, based on signals received from a base station, a set of power offset values, decode, based on signals received from the base station, a downlink control information (DCI), the DCI indicating a power offset value from the set of power offset values and determine a transmission power for a downlink signal to be transmitted by the base station based on at least the power offset value indicated by the DCI.

Still further exemplary embodiments are related to an apparatus of a base station, the apparatus having processing circuitry configured to configure transceiver circuitry to transmit a set of power offset values to a user equipment (UE) and configure transceiver circuitry to transmit a downlink control information (DCI), the DCI indicating a power offset value from the set of power offset values, wherein the UE determines a transmission power for a downlink signal to be transmitted by the base station based on at least the power offset value indicated by the DCI.

Additional exemplary embodiments are related to a processor configured to configure transceiver circuitry to transmit a set of power offset values to a user equipment (UE) and configure transceiver circuitry to transmit a downlink control information (DCI), the DCI indicating a power offset value from the set of power offset values, wherein the UE determines a transmission power for a downlink signal to be transmitted by the base station based on at least the power offset value indicated by the DCI,

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a signaling diagram for fast dynamic transmission power indication according to various exemplary embodiments.

FIG. 5 shows a carrier aggregation (CA) scenario for transmission unit (TxRU) adaptation according to various exemplary embodiments.

### DETAILED DESCRIPTION

The exemplary embodiments may be further understood with reference to the following description and the related appended drawings, wherein like elements are provided with the same reference numerals. The exemplary embodiments relate to network power saving. As will be described in more detail below, the exemplary techniques introduced herein may be used to mitigate the impact of certain types of network power saving mechanisms on user equipment (UE) and/or network performance.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network and base station.

The gNB may also be equipped with multiple transceiver units (TxRUs). Those skilled in the art will understand that a TxRU generally refers to a signal processing component that is mapped to one or more antenna elements and/or one or more antenna ports. The exemplary embodiments are further described with regard to TxRU adaptation for network power saving where transceiver chains are dynamically switched on and off based on factors such as, but not limited to, traffic load and a number of connected devices.

In gNBs with active antenna systems, the energy consumed by the multitude of transceiver chains may account for a significant part of the total consumed network energy. Generally, the power consumption scales with the applied hardware. For example, the greater the number of transceiver chains with power amplification applied typically leads to more power being consumed by the gNB. To provide another example, the greater the number of active antennas typically leas to more power being consumed by the baseband processing scales of the gNB. A significant amount of energy may be saved by utilizing only a subset of the available TxRUs and/or antennas. Accordingly, a mechanism like TxRU adaptation may be used where transceiver chains are dynamically switched on and off for network power saving. However, reference to TxRU adaptation and switching on and off transceiver chains is provided for illustrative purposes and is not intended to limit the exemplary embodiments in any way. The exemplary embodiments may be utilized in conjunction with any network power saving mechanism where one or more components (e.g., TxRUs, transceiver chains, transmitter chains, radio frequency (RF) chains, antenna elements, antenna panels, antenna ports, any combination thereof, etc.) are dynamically switched off, put to sleep, in hibernation or in deactivation for network power saving.

When transceiver chains are switched off and on, the maximum transmission power for the gNB may be scaled up and down respectively. To provide one general example, the maximum transmission power may be reduced when an active TxRU and/or power amplification number is reduced, e.g., a subset of transceiver chains are switched off. It has been identified that this type of network power saving technique may result in varied transmission power for downlink signals such as, but not limited to, synchronization signal block (SSB) for beam management, channel state information (CSI)-reference signal (RS) for beam management, CSI-RS for CSI feedback and demodulated reference signal (DMRS) for physical downlink shared channel (PDSCH). From the perspective of the UE 110, an unknown transmission power variance may negatively impact uplink power control mechanisms and random access channel (RACH) procedures.

Under conventional circumstances, to indicate the updated transmission power for certain downlink signals to the UE, the gNB may transmit a transmission power indication via a system information block 1 (SIB1) or radio resource control (RRC) signaling. However, these types of procedures are performed on a per-UE basis which may lead to a significant signaling overhead. In addition, the speed with which these types of procedures may be performed is undesirable for the dynamic nature of TxRU adaptation.

According to some aspects, the exemplary embodiments introduce techniques related to signaling a transmission power indication for downlink signals to avoid the types of issues referenced above and improve the efficiency of network power saving mechanisms such as TxRU adaptation. The exemplary techniques introduced herein may be used independently from one another, in conjunction with other currently implemented transmission power indication techniques, future implementations of transmission power indication techniques or independently from other transmission power indication techniques.

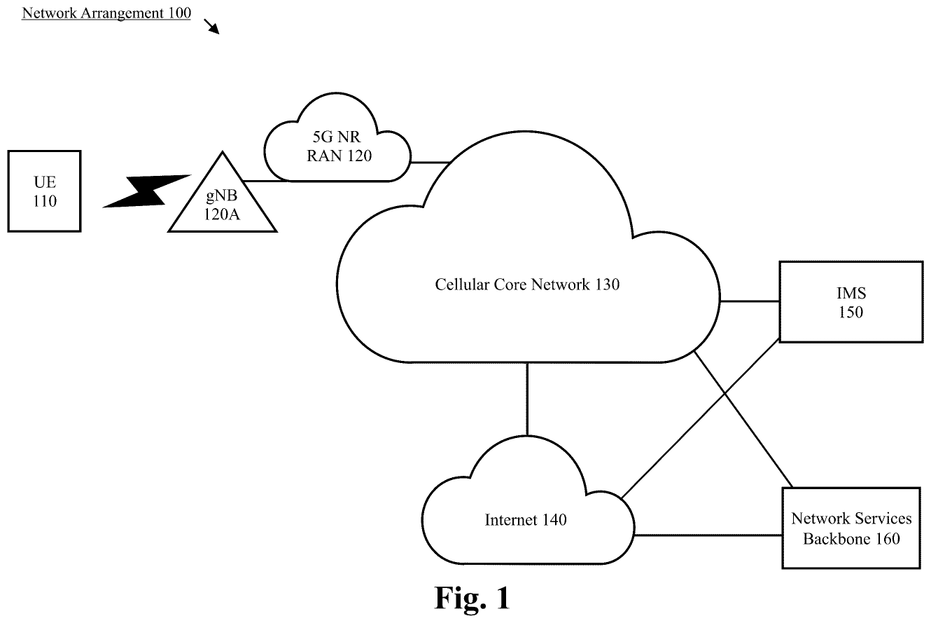

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam. As indicated above, in some examples, the terms “TRP” and “cell” may be used interchangeably to generally refer to the same connection and/or node.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

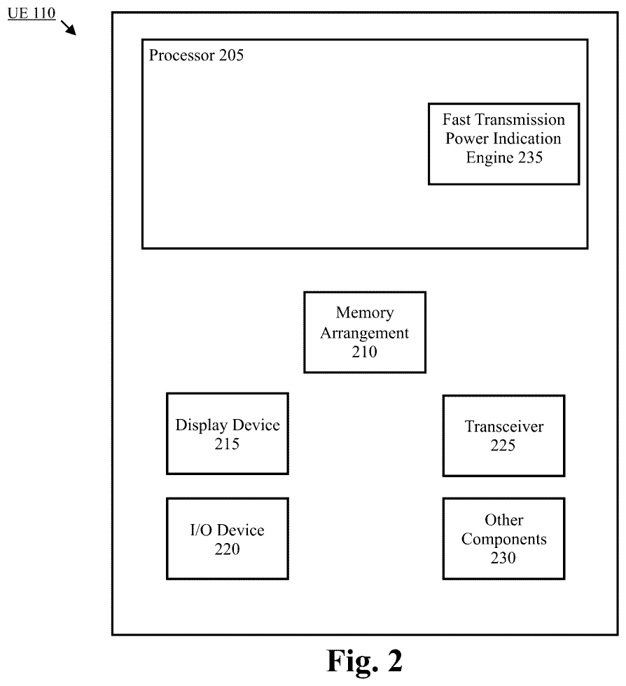

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a fast transmission power indication engine 235. The fast transmission power indication engine 235 may perform various operations related to determining whether a change to transmission power has occurred for various types of downlink signals and/or channels. To provide some general examples, the fast transmission power engine 235 may perform operations such as, but not limited to, receiving a set of power offset values, receiving downlink control information (DCI) and determining a transmission power for certain downlink signals and/or channels that are to be received by the UE 110.

The above referenced engine 235 being applications (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 may encompass an advanced receiver (e.g., E-MMSE-RC, R-ML, etc.) for MU-MIMO. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

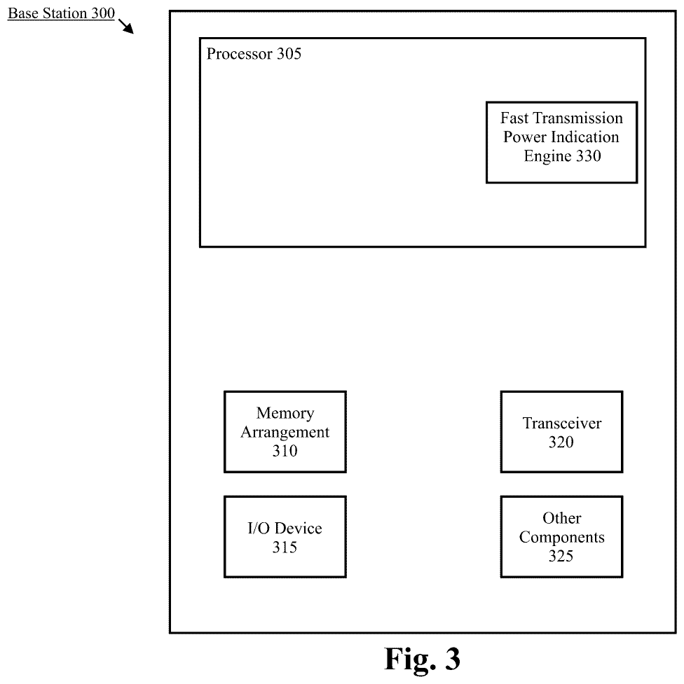

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

The processor 305 may be configured to execute a plurality of engines for the base station 300. For example, the engines may include a fast transmission power indication engine 330. The fast transmission power indication engine 330 may perform various operations related to signaling that a change to transmission power has occurred for various types of downlink signals and/or channels. To provide some general examples, the fast transmission power engine 330 may perform operations such as, but not limited to, transmitting a set of power offset values and DCI that enables the UE 110 to determine a transmission power for certain downlink signals and/or channels.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

According to some aspects, the exemplary embodiments relate to TxRu adaptation. As will be described in more detail below, the exemplary embodiments introduce techniques for fast transmission power indication for downlink signals and/or channels to support the implementation of network power saving parameters such as TxRU adaptation.

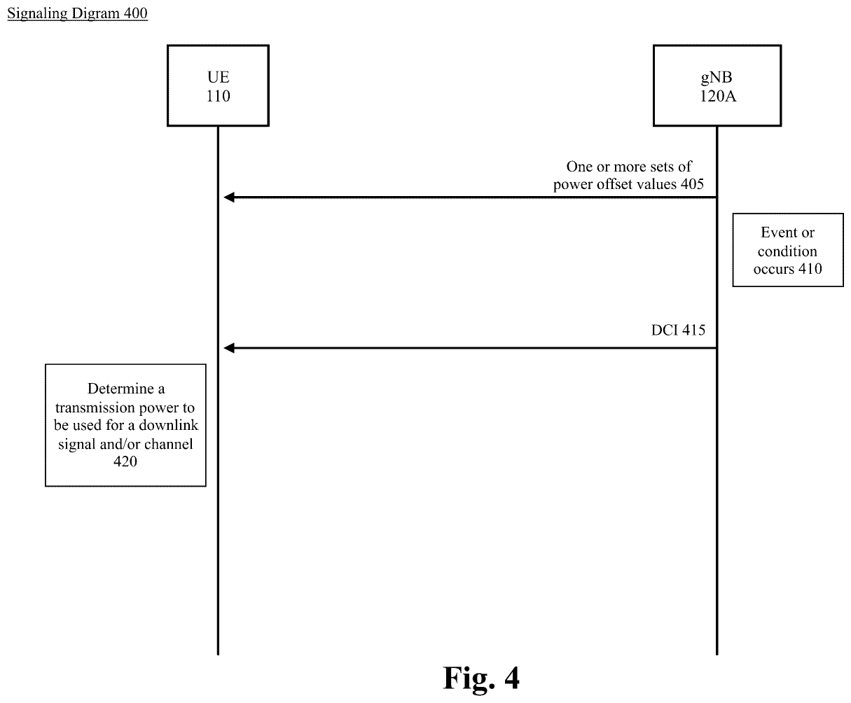

FIG. 4 shows a signaling diagram 400 for fast dynamic transmission power indication according to various exemplary embodiments. The signaling diagram 400 includes the UE 110 and the gNB 120A of the network arrangement 100 of FIG. 1.

In 405, the gNB 120A transmits one or more sets of power offset values are provided to the UE 110. As will be described in more detail below, the power offset values may enable the UE 110 to determine a transmission power for certain types of downlink signals and/or channels. The one or more sets of power offset values may be provided by SIB information, dedicated radio resource control (RRC) signaling or in any other appropriate manner. Additional details regarding the power offset values are provided below during the description of 415 of the signaling diagram 400.

In 410, an event or condition occurs that causes a change to a transmission power parameter for one or more types of downlink signals and/or channels. For example, the gNB 120A may switch on or off a component in accordance with network power saving (e.g., TxRUs, transceiver chains, transmitter chains, RF chains, antenna elements, antenna panels, any combination thereof, etc.). The examples provided below are described with regard to dynamic TxRU adaptation being utilized by the gNB 120A which may include dynamically switching on and off transceiver chains for network power saving. As a result, a transmission power update for one or more types of downlink signals and/or channels is triggered. However, the manner in which the transmission power update is triggered and determined is beyond the scope of exemplary embodiments. Instead, the exemplary embodiments introduce techniques for signaling the transmission power indication after an event or condition causes a change to a transmission power parameter for one or more downlink signals and/or channels.

In 415, downlink control information (DCI) is transmitted to the UE 110 by the gNB 120A. The DCI may notify the UE 110 that a transmission power update has occurred at the gNB 120A. In addition, the DCI may indicate one or more of the previously provided power offset values that may be used to determine the transmission power that is to be used by the gNB 120A for a subsequent downlink transmission. In some embodiments, the DCI in 415 is an already defined DCI format that has been configured to provide this type of information.

In other embodiments, a new DCI format has been introduced for indicating a transmission power update for certain types of downlink signals to one or more UEs. Throughout this description, the new DCI format may be referred to as “DCI format 2_X.” The exemplary DCI format 2_X may be cyclic redundancy check (CRC) scrambled by a dedicated transmission power control (TPC)_X_radio network temporary identifier (RNTI). The TPC_X_RNTI may be hard encoded in 3GPP Specifications or explicitly provided to the UE 110 by SIB information, dedicated RRC signaling or in any other appropriate manner. However, reference to DCI format 2_X is merely provided for illustrative purposes, the 2_X classification provided herein may serve as a placeholder. In an actual deployment scenario, the new DCI format may be assigned any appropriate number or label. Similarly, reference to TPC_X_RNTI is also provided for illustrative purposes, the “X” classification provided herein may serve as a placeholder. In an actual deployment scenario, the RNTI may be assigned any appropriate number or label.

As described above, in 405, one or more sets of power offset values may be provided to the UE 110. The signaling diagra00 is described with regard to power offset values for synchronization signal block (SSB) transmission power. The power offset values for SSB transmission power may be represented by

$${β}_{offset}^{SSB , 0} , {β}_{offset}^{SSB , 1} , … {β}_{offset}^{SSB , N - 1}$$

where the value of (N) is based on a number of varied TxRUs for TxRU adaptation. In addition, the exemplary embodiments are described with regard to power offset values for channel state information (CSI)-reference signal (RS) transmission power. The power offset values for CSI-RS transmission power may be represented by

$${β}_{offset}^{SSB , 0} , {β}_{offset}^{SSB , 1} , … {β}_{offset}^{SSB , M - 1}$$

where (M) is based on a number of varied TxRUs for TxRU adaptation. In some examples, N may be equal to M. However, there may be scenarios where the number of varied TxRUs for SSB transmission is different than the number of varied TxRUs for CSI-RS transmission and thus, N and M may be different values. Reference to SSB transmission power and CSI-RS transmission power is merely provided for illustrative purposes, the exemplary embodiments are not limited to these types of downlink signals. That is, the exemplary embodiments may apply to any appropriate type of downlink signal and/or channel.

Different approaches may be used to provide a set of power offset values for SSB transmission power

$$( e . g . , {β}_{offset}^{SSB , i} , 0 \leq i < N )$$

and/or a set of power offset values for CSI-RS transmission power

$$( e . g . , {β}_{offset}^{SSB , i} , 0 \leq j < M )$$

for TxRU adaptation. In one example,

$${β}_{offset}^{SSB , i} , i \geq 0$$

values may be provided to the UE 110 by SIB information. In another example,

$${β}_{offset}^{SSB , i} , i \geq 0 and / or {β}_{offset}^{CSI - RS , j} , j \geq 0$$

values may be provided by dedicated RRC signaling. However, the exemplary embodiments are not limited to this approach and may utilize any appropriate mechanism to provide one or more sets of power offset values to the UE 110.

Returning to 415, the DCI may indicate to the UE 110 which power offset value from a set of power offset values are to be used to determine a transmission power. In some embodiments, the DCI format 2_X may include a SSB power scaling indication (SSB-PSI) comprising 0 or [log₂N] bits. The presence of this field may depend on whether TxRU adaptation is to be applied by the gNB 120A for SSB transmission. This field may be used to select one power offset value from

$${β}_{offset}^{SSB , i} , 0 \leq i < N$$

values provided in 405.

In some embodiments, the DCI format 2_X may include a CSI-RS-PSI comprising 0 or [log₂M] bits. The presence of this field may depend on whether TxRU adaptation is to be applied by the gNB 120A for CSI-RS transmission. In addition, in some embodiments, a certain value (e.g., 0) in this field may indicate that TxRU adaptation is only applied for SSB transmission and not CSI-RS transmission. Like the SSB-PSI, the CSI-RS-PSI may be used to select one power offset value from

$${β}_{offset}^{CSI - RS , j} , 0 \leq j < N$$

values provided in 405. In some embodiments, a non-zero power (NZP)-CSI-RS resource set associated with the indicated CSI-RS-PSI may be explicitly indicated in the DCI format 2_X.

Configuration information for the DCI format 2_X may be provided to the UE 110 in one or more messages, hard encoded in 3GPP specifications, a combination thereof or in any other appropriate manner. For example, the size of the DCI format 2_X may be explicitly indicated by SIB (for both RRC idle mode and RRC connected mode UEs) or dedicated RRC signaling. In another example, the size of the DCI format 2_X may be predefined.

In addition to the size of the DCI format 2_X configuration information related to the search space set may also be provided to the UE 110 in any appropriate manner. For example, the search space set of DCI format 2_X may be a type3-physical downlink control channel (PDCCH) common search space (CSS) configured by SIB or dedicated RRC signaling. If not configured, type0-PDCCH CCSS may be used as a default. In another example, the control channel element (CCE) aggregation level (AL) and the number of PDCCH candidate per CCE AL may be hard encoded in 3GPP specification. For instance, to minimize negative impacts on UE power consumption, only AL 16 may be allowed with one candidate for DCI format 2_X transmission. However, the above reference configuration information and the manner in which it is provided to the UE 110 is merely provided for illustrative purposes. The network may provide the UE 110 with configuration information related to the reception of and or configuration of DCI format 2_X in any appropriate manner.

According to some aspects, the exemplary DCI format 2_X may consist of (B) blocks where each block includes multiple sub fields. For example, a DCI format 2_X block may include a sub field for parameters such as, but not limited to, SSB-PSI, CSI-RS-PSI and an NZP-CSI-RS resource set (CSI-RS-RESET) associated with the CSI-RS-PSI. In some embodiments, a block may correspond to a specific component carrier (CC). However, the exemplary DCI format 2_X is not required to be arranged in multiple blocks nor is each block required to correspond to a CC. The contents of the exemplary DCI format 2_X may be arranged in any appropriate manner and correspond to any appropriate number and/or type of component (e.g., CC, device, network component, channel, etc.).

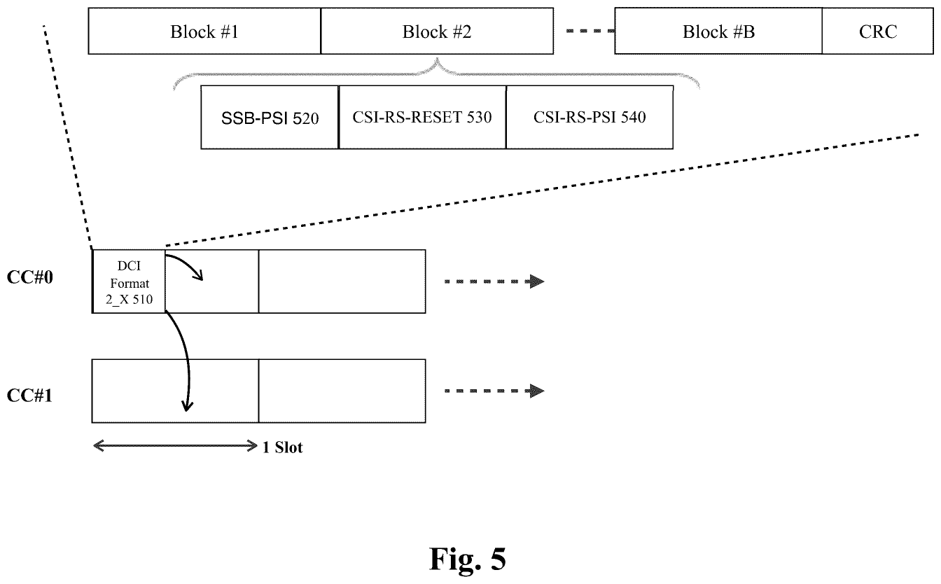

The DCI format 2_X may be provided to a group of UEs that are each configured with one or more CCs. Thus, from the perspective of the UE 110 only one or more blocks of the DCI format 2_X may be relevant to UE 110 downlink reception. To determine the arrangement of blocks and/or the starting position of a block within the DCI format 2_X, the network may provide this type of information to the UE 110 using SIB1, dedicated RRC signaling or any other appropriate type of mechanism. For example, UEs operating in RRC idle mode may receive this type of configuration information for the DCI format 2_X via SIB1 and UEs operating in RRC connected mode may receive this this type of configuration information for the DCI format 2_X via dedicated RRC signaling. Prior to describing the remaining portions of the signaling diagram 400 of FIG. 4, an example of DCI format 2_X arranged in multiple blocks is described below with regard to FIG. 5.

FIG. 5 shows a carrier aggregation (CA) scenario 500 for TxRU adaptation according to various exemplary embodiments. Initially, assume a scenario in which the UE 110 is configured with at least two CCs, CC #0 and CC #1. In addition, the DCI format 2×510 may comprise B blocks (e.g., Block #1, Block #2 . . . . Block #B). Each block may include three sub-fields, an SSB-PSI subfield 520, CSI-RS-RESET subfield 530 and a CSI-RS-PSI subfield 540. It should be understood that FIG. 5 shows an expanded view for only Block #2 but each of the other (B) blocks may contain the same type of subfields. This example is merely provided for illustrative purposes and is not intended to limit the exemplary embodiments in any way. The exemplary DCI format 2_X may be arranged in any appropriate manner.

In the CA scenario 500, the DCI format 2_X 510 is transmitted on CC #0 at a first time during a first slot. The UE 110 is configured with at least two CCs where Block #1 of the DCI format 2_X 510 corresponds to CC #0 and Block #2 of the DCI format 2_X 510 corresponds to CC #1. Thus, DCI received on a first CC may include parameters for that enable the UE 110 to determine the transmission power to be used for downlink signals and/or channels on a second different CC. For instance, the SSB-PSI 520 in Block #2 may indicate a power offset value from the previously provided one or more sets of power offset values and enable the UE 110 to determine the SSB transmission power on CC #1. Similarly, the SSB-PSI in Block #1 (not shown in FIG. 5) may indicate a power offset value from the previously provided one or more sets of power offset values and enable the UE 110 to determine the SSB transmission power on CC #1.

Returning to the signaling diagram 400, in 420, the UE 110 determines a transmission power to be used for a downlink signal and/or channel based on the indicated power offset value. For example, the indicated

$${β}_{offset}^{SSB , i} , 0 \leq i < N$$

may be used by the UE 110 to determine the actual transmission power for SSB. The transmission power for SSB may be represented as

$${P}_{SSB} = {P}_{O \_ SSB} * {β}_{offset}^{SSB , i}$$

where

$${β}_{offset}^{SSB , i}$$

is dynamically indicated by the gNB 120A using DCI and P_{O_SSB} represents the average energy per reference element (EPRE) of the resource elements that carry SSB measured in decibels per milliwatt (dBm) which may be indicated by synchronization signal (ss)-physical broadcast channel (PBCH)-Block power information element (IE) in SIB1. In another example, the indicated

$${β}_{offset}^{CSI - RS , j} , 0 \leq j < N$$

may be used by the UE 110 to determine the actual transmission power for CSI-RS. The transmission power for CSI-RS may be represented by

$${P}_{SSB} = {P}_{O \_ SSB} * {β}_{offset}^{CSI - RS , j} * {O}_{CSI - RS}$$

where

$${β}_{offset}^{CSI - RS , j}$$

is dynamically indicated by the gNB 120A using DCI, P_{O_SSB} represents the average EPRE of the resource elements that carry SSB measured in dBm which may be indicated by ss-PBCH-Block power IE in SIB1 and O_{CSI-RS} may represent a power offset of NZP-CSI-RS resource elements to SSB resource element indicated by dedicated RRC signaling.

As mentioned above, an unknown transmission power variance may impact procedures such as, but not limited to, uplink power control, RACH procedure, beam failure recovery (BFR), beam failure detection (BFD). Accordingly, the signaling diagram 400 may provide a fast transmission power indication with minimized signaling overhead to avoid scenarios in which a transmission power variance is unknown to the UE 110.

### EXAMPLES

In a first example, a method performed by a user equipment (UE), comprising receiving a set of power offset values from a base station, receiving a downlink control information (DCI), the DCI indicating a power offset value from the set of power offset values and determining a transmission power for a downlink signal to be transmitted by the base station based on at least the power offset value indicated by the DCI.

In a second example, the method of the first example, wherein the set of power offset values are used for transmission power determination of synchronization signal block (SSB).

In a third example, the method of the second example, wherein determining the transmission power for the downlink signal is further based on an average energy per reference element (EPRE) of the resource elements that carry SSB.

In a fourth example, the method of the third example, wherein the EPRE is indicated by an information element (IE) provided in a system information block (SIB).

In a fifth example, the method of the first example, wherein the set of power offset values are used for transmission power determination of channel state information (CSI)-reference signal (RS).

In a sixth example, the method of the fifth example, wherein determining the transmission power for the downlink signal is further based on an average energy per reference element (EPRE) of the resource elements that carry synchronization signal block (SSB) and a power offset of a non-zero power (NZP)-CSI-RS reference element relative to the EPRE of SSB.

In a seventh example, the method of the sixth example, wherein the power offset of the NZP CSI-RS is provided by dedicated radio resource control (RRC) signaling.

In an eighth example, the method of the first example, wherein cyclic redundancy check (CRC) bits of the DCI are scrambled by a dedicated radio network temporary identifier (RNTI).

In a ninth example, the method of the eighth example, wherein the dedicated RNTI is provided to the UE using radio resource control (RRC) signaling.

In a tenth example, the method of the first example, wherein the DCI comprises multiple subfields, each subfield comprising at least a synchronization signal block (SSB) power scaling indication (PSI).

In an eleventh example, the method of the first example, wherein the DCI comprises multiple subfields, each subfield comprising at least a channel state information (CSI)-reference signal (RS) power scaling indication (PSI).

In a twelfth example, the method of the first example, wherein each subfield further comprises a non-zero power (NZP)-CSI-RS resource set associated with the CSI-RS-PSI.

In a thirteenth example, the method of the first example, wherein the size of the DCI is indicated by a system information block (SIB).

In a fourteenth example, the method of the first example, wherein the DCI is received in a type 3 physical downlink control channel (PDCCH) common search space (CSS).

In a fifteenth example, the method of the first example, wherein the DCI comprises multiple blocks, each block comprising at least one of a channel state information (CSI)-reference signal (RS) power scaling indication (PSI) and a synchronization signal block (SSB) PSI, wherein a first block of the multiple blocks corresponds to a first component carrier (CC) and second block of the multiple blocks corresponds to a second different CC.

In a sixteenth example, the method of the fifteenth example, wherein the association between a block in the DCI and a corresponding CC is configured by a system information block (SIB) or dedicated radio resource control (RRC) signaling.

In a seventeenth example, a processor configured to perform any of the methods of the first through sixteenth examples.

In an eighteenth example, a user equipment (UE) comprising a transceiver configured to communicate with a network and a processor communicatively coupled to the transceiver and configured to perform any of the methods of the first through sixteenth examples.

In a nineteenth example, a method is performed by a base station, comprising transmitting a set of power offset values to a user equipment (UE) and transmitting a downlink control information (DCI), the DCI indicating a power offset value from the set of power offset values, wherein the UE determines a transmission power for a downlink signal to be transmitted by the base station based on at least the power offset value indicated by the DCI.

In a twentieth example, the method of the nineteenth example, wherein the set of power offset values are used for a transmission power determination of synchronization signal block (SSB).

In a twenty first example, the method of the twentieth example, wherein determining the transmission power for the downlink signal by the UE is further based on an average energy per reference element (EPRE) of the resource elements that carry SSB.

In a twenty second example, the method of the twenty first example, further comprising transmitting a system information block (SIB) comprising an information element (IE), the IE indicating the EPRE.

In a twenty third example, the method of the nineteenth example, wherein the set of power offset values are used for a transmission power determination of channel state information (CSI)-reference signal (RS).

In a twenty fourth example, the method of the twenty third example, wherein determining the transmission power for the downlink signal by the UE is further based on an average energy per reference element (EPRE) of the resource elements that carry synchronization signal block (SSB) and a power offset of a non-zero power (NZP)-CSI-RS reference element relative to the EPRE of SSB.

In a twenty fifth example, the method of the twenty fourth example, further comprising transmitting a radio resource control (RRC) signal to the UE, the RRC signal indicating the power offset of the NZP CSI-RS.

In a twenty sixth example, the method of the nineteenth example, wherein the cyclic redundancy check (CRC) bits of the DCI are scrambled by a dedicated radio network temporary identifier (RNTI).

In a twenty seventh example, the method of the twenty sixth example, wherein the dedicated RNTI is provided to the UE using radio resource control (RRC) signaling.

In a twenty eighth example, the method of the nineteenth example, wherein the DCI comprises multiple subfields, each subfield comprising at least a synchronization signal block (SSB) power scaling indication (PSI).

In a twenty ninth example, the method of the nineteenth example, wherein the DCI comprises multiple subfields, each subfield comprising at least a channel state information (CSI)-reference signal (RS) power scaling indication (PSI).

In a thirtieth example, the method of the twenty ninth example, wherein each subfield further comprises a non-zero power (NZP)-CSI-RS resource set associated with the CSI-RS-PSI.

In a thirty first example, the method of the nineteenth example, wherein the size of the DCI is indicated to the UE by a system information block (SIB).

In a thirty second example, the method of the nineteenth example, wherein the DCI comprises multiple blocks, each block comprising at least one of a channel state information (CSI)-reference signal (RS) power scaling indication (PSI) and a synchronization signal block (SSB) PSI, wherein a first block of the multiple blocks corresponds to a first component carrier (CC) and second block of the multiple blocks corresponds to a second different CC.

In a thirty third example, the method of the nineteenth example, wherein the association between a block in the DCI a corresponding CC is configured by a system information block (SIB) or a dedicated radio resource control (RRC) signaling.

In a thirty fourth example, a processor configured to perform any of the methods of the nineteenth through thirty third examples.

In an thirty fifth example, a base station comprising a transceiver configured to communicate with a user equipment (UE) and a processor communicatively coupled to the transceiver and configured to perform any of the methods of the nineteenth through thirty third examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, based on signals received from a base station, a set of power offset values;
decode, based on signals received from the base station, a downlink control information (DCI), the DCI indicating a power offset value from the set of power offset values; and
determine a transmission power for a downlink signal to be transmitted by the base station based on at least the power offset value indicated by the DCI.

2. The apparatus of claim 1, wherein the set of power offset values are used for transmission power determination of synchronization signal block (SSB).

3. The apparatus of claim 2, wherein determining the transmission power for the downlink signal is further based on an average energy per reference element (EPRE) of the resource elements that carry SSB.

4. The apparatus of claim 3, wherein the EPRE is indicated by an information element (IE) provided in a system information block (SIB).

5. The apparatus of claim 1, wherein the set of power offset values are used for transmission power determination of channel state information (CSI)-reference signal (RS).

6. The apparatus of claim 5, wherein determining the transmission power for the downlink signal is further based on an average energy per reference element (EPRE) of the resource elements that carry synchronization signal block (SSB) and a power offset of a non-zero power (NZP)-CSI-RS reference element relative to the EPRE of SSB.

7. The apparatus of claim 6, wherein the power offset of the NZP CSI-RS is provided by dedicated radio resource control (RRC) signaling.

8. The apparatus of claim 1, wherein cyclic redundancy check (CRC) bits of the DCI are scrambled by a dedicated radio network temporary identifier (RNTI).

9. The apparatus of claim 8, wherein the dedicated RNTI is provided to the UE using radio resource control (RRC) signaling.

10. The apparatus of claim 1, wherein the DCI comprises multiple subfields, each subfield comprising at least a synchronization signal block (SSB) power scaling indication (PSI).

11. The apparatus of claim 1, wherein the DCI comprises multiple subfields, each subfield comprising at least a channel state information (CSI)-reference signal (RS) power scaling indication (PSI).

12. The apparatus of claim 11, wherein each subfield further comprises a non-zero power (NZP)-CSI-RS resource set associated with the CSI-RS-PSI.

13. The apparatus of claim 1, wherein the size of the DCI is indicated by a system information block (SIB).

14. The apparatus of claim 1, wherein the DCI is received in a type 3 physical downlink control channel (PDCCH) common search space (CSS).

15. The apparatus of claim 1, wherein the DCI comprises multiple blocks, each block comprising at least one of a channel state information (CSI)-reference signal (RS) power scaling indication (PSI) and a synchronization signal block (SSB) PSI,
wherein a first block of the multiple blocks corresponds to a first component carrier (CC) and second block of the multiple blocks corresponds to a second different CC.

16. The apparatus of claim 15, wherein the association between a block in the DCI and a corresponding CC is configured by a system information block (SIB) or dedicated radio resource control (RRC) signaling.

17. An apparatus of a base station, the apparatus comprising processing circuitry configured to:
configure transceiver circuitry to transmit a set of power offset values to a user equipment (UE); and
configure transceiver circuitry to transmit a downlink control information (DCI), the DCI indicating a power offset value from the set of power offset values, wherein the UE determines a transmission power for a downlink signal to be transmitted by the base station based on at least the power offset value indicated by the DCI.

18. The apparatus of claim 17, wherein the set of power offset values are used for a transmission power determination of synchronization signal block (SSB).

19. The apparatus of claim 18, wherein determining the transmission power for the downlink signal by the UE is further based on an average energy per reference element (EPRE) of the resource elements that carry SSB.

20. The apparatus of claim 19, wherein the processing circuitry is further configured to:
configure transceiver circuitry to transmit a system information block (SIB) comprising an information element (IE), the IE indicating the EPRE.
